(19) United States
(12) Patent Application Publication
(10) Pub. No.: US 2006/0086326 A1
(43) Pub. Date: Apr. 27, 2006

(54) One piece cast ferrous crown piston for internal combustion engine

(75) Inventor: Robert Rasmussen, Henderson, NV (US)

Correspondence Address: WILLIAM S. LIGHTBODY, ATRIUM SUITE 100, 32600 FAIRMOUNT BLVD., PEPPER PIKE, OH, 44124, US

(73) Assignee: IPD, INC.

(21) Appl. No.: 10/973,006

(22) Filed: Oct. 25, 2004

(51) Int. Cl. F02F 3/16

(52) U.S. Cl. 123/41.35; 123/193.6

(57) ABSTRACT

A one-piece piston utilizing an investment cast ferrous or similar high strength material with a piston crown of a constant thickness.

### FIELD TO WHICH THE INVENTION RELATES

This invention relates to a one piece piston which incorporates a high strength cast ferrous crown having a constant wall thickness together with an integral machined piston skirt attached to the piston/connecting rod with a wrist pin.

### BACKGROUND OF THE INVENTION

Internal combustion (IC) engines have been utilized for years in stationary and mobile applications. Examples of the former include pumps, generators, oil field equipment, compressors, and the like, while examples of the latter include heavy tractors, trucks, earthmoving equipment, automobiles, marine propulsion and auxiliary uses and the like.

Recent developments to the numerous types of IC engines in the last fifteen years have demonstrated that in the diesel engine and high power gaseous fueled applications of such engines, substantial thermal efficiencies, increases in power as a ratio of engine displacement, and reductions in emission can be achieved by increasing the combustion pressure and in the case of the diesel engine, the fuel injection pressures.

These increases in mechanical and thermal efficiency have been achieved through increasing intake air pressure as a factor of several magnitudes of atmospheric pressure by the utilization of mechanical and/or turbo supercharging, increasing diesel fuel injection pressure and precision mechanical and/or electronic means of controlling the operation and thermal condition of the subject IC engine by the use of electronic engine management systems.

These developments have all resulted in an increase in the temperature of the combustion process in both the diesel and gaseous fuel iterations of the IC engine which has manifested itself in the form of piston top (crown) temperatures that exceed the thermal limits of known materials and applications.

Known methods of cooling such pistons by use of oil jets from beneath and temporary retention and heat rejection by captured oil delivered by such means have failed to sole the problems satisfactorily in most applications.

The makers of IC engines and parts have further sought many avenues of materials and design to sole the dual problems of material strength at elevated temperatures and acceptable material weight.

This concurrent need for thermal strength and acceptable weight is the result of the piston in an IC engine being a moving, in fact, reciprocating part that moves through the piston bore of such engines at high linear speeds in order to translate combustion pressure on the piston through connecting rod into rotational energy at the crankshaft.

In addition, the piston in its cylindrical bore has been traditionally and remains sealed between the combustion part located between the top of the moving piston and the cylinder top or head and the remainder of the engine by a multiplicity of sealing rings that are installed in circumferential groove machined into the outer diameter of the piston itself, each ring being in the form generally of a rectangular cross section that is radially cut to permit its elongation and installation in the grove in the piston.

In the most recent development of IC technology it has further been proven that the closer that the top most of the aforementioned sealing rings can be installed to the top of the piston itself, the less stagnant or residual gasses remaining from the preceding combustion event will be present and the amount of certain undesirable combustion by products including but not limited to oxides of nitrogen and monoxides of carbon will be substantially minimized by the engine in its operation.

This desire to particularly locate the topmost piston ring has by itself posed unique material and design problems that have not been satisfactorily addressed in a cost effective manner by existing designs and iterations of piston technology.

Although there have been numerous methods applied by the makers of engines and pistons to solve these multiple objectives (high strength, thermal stability, ring groove stability, production costs) none have been entirely satisfactory from either a weight or strength standpoint, or alternatively, if such a design and operational balance is approached, it is by methods and designs that are substantially more costly to produce that the prior common aluminum IC piston that has been the standard for over 60 years.

In this search for acceptable dual qualities of thermal strength and acceptable component weight, among the methods used are the following, each with its unsatisfactory characteristics noted:
1. High strength aluminum pistons:
   Heat resistant alloys are costly and difficult to forge or cast, will not withstand combustion pressures and temperatures at existing engine power levels, and prematurely fail in service;
2. Cast or forged aluminum or aluminum alloy pistons with cast in place ferrous inserts for ring grooves and piston tops/combustion cavities:
   Costly to manufacture and at high temperatures the remaining aluminum eventually erodes or loses necessary thermal strength;
3. One piece cast iron pistons that mimic aluminum designs:
   Heavy weight and inconsistent expansion/thermal characteristics limit applications and combustion pressures due to poor weight strength ratio;
4. Two piece pistons with forged and machined ferrous crowns connected to cast/forged and machined aluminum skirts by the use of high strength elongated gudgeon/wrist pins:
   Very high cost to manufacture piston crowns and skirts in separate steps;
   Substantially heavier that one piece design and requires heavier rotating assembly to accommodate and compensate;
5. Forged and machined ferrous piston crowns that are joined by mechanical means or friction welding to ferrous or non-ferrous skirts with a common piston/gudgeon pin:
   Very costly to manufacture, compromised thermal characteristics and unsatisfactory in long term service;
6. Forged and machined one piece ferrous skeleton piston:
   Very costly to manufacture from a forging to achieve the requisite constant and controlled cross section of the crown and skirt, requires extensive and costly machining processes.

In addition, since these pistons, of whatever design, do wear in service, particularly in comparison to the life of the entire engine where pistons may be replaced five or ten times in a typical engine's installed service life; thus for this reason, a substantial market has developed for pistons utilized both in the initial, typically name brand, production of the engines as well as in the aftermarket repair and rebuilding of the engines.

In consideration of the above, piston manufacturers are constantly developing new technology relative to existing designs in a search for longevity of initially installed pistons as well as those used in the rebuilt/remanufactured processes in order to lengthen the service life of a particular engine block.

Examples of these efforts include the Detroit diesel engine as set forth in U.S. Pat. No. 5,299,538; the Cummings piston as set forth in U.S. Pat. Nos. 5,144,844 and 5,339,352; the Mercedes engine as set forth in U.S. Pat. Nos. 3,363,608 and 4,413,597; and, the Caterpillar piston as set forth in U.S. Pat. No. 4,056,044.

In addition to the above, additional piston designs have been developed by various manufacturers in order to increase the initial and subsequent service life of the engine. Examples of this are the Mack piston as set forth in U.S. Pat. No. 4,180,027.

The purpose of these various engine and piston designs is said to provide increased thermal equalization, mechanical stability, and longer service life. While they may do so, the cost of the tooling and manufacturing processes is significant, and the secondary machining operations are numerous, complicated, and costly; finally not always resulting in acceptable in service life or desired engine performance characteristics.

### SUMMARY OF THE INVENTION

The present invention is directed to a two piece piston having a cast ferrous or similar high strength and heat resistant material piston crown of interior dimensions of net values which provides a piston crown having a controlled and constant thickness throughout to ensure mechanical and thermal consistency without any additional machining of the interior diameters and other surfaces of the piston crown and this is attached to a separate skirt by the use of the wrist pin; said skirt made of ferrous or non-ferrous materials by casting or other means.

This use in manufacturing and service of a net dimension casting also improves the distribution of heat within such crown. Thus invention also increases the efficiency of heat transfer to the cooling oil typically present in the piston through cooling jets or reservoirs of oil impinged upon the piston from beneath and contained therein, respectively. This in, turn improves the thermal transfer between the piston crown and the cooling system of the engine. In addition, the utilization of a cast net to dimension piston interior reduces the areas of the piston which may be usually subject to high temperature differentials thus improving the longevity of the piston.

It is an objective of this invention to reduce any differential wear about the circumference of the piston by maintaining constant cross sections throughout;

It is another objective of this invention to reduce the temperature differential in the various parts of a piston of an internal combustion engine;

It is a further objective of this invention to provide for a stronger piston that is more adaptable to the cylinder liner and more evenly transfers heat subsequent to combustion thereto, particularly at the location of the top or uppermost compression sealing ring;

It is a further objective of this invention to increase the service life of pistons in an internal combustion engine by manufacturing it from wear resistant ferrous materials that further remain dimensionally stable under conditions of high heat and pressure;

It is another objective of this invention to permit the stable location of the top piston ring groove and the top piston ring at a point very close to the top of the piston crown to minimize the entrapment of residual and stagnant gases to decrease exhaust emissions;

It is yet another objective of this invention to materially and substantially reduce the complexity of manufacturing of pistons for an internal combustion engine by casting them to dimensionally net shape and size and by therefore eliminating machining operations necessary to achieve constant and correct cross sectional dimensions of the crown and attendant skirt;

It is further another object of this invention to simplify the construction of pistons by enhancing the two piece skirt design with the cast ferrous crown attached to a ferrous or non-ferrous skirt;

It is another objective of this invention to produce a piston having one piece with a wrist pin of a length necessary only to adequately transfer the combustion loads from the piston crown subject to the combustion pressure in operation to the connecting rod and thus substantially reduce weight in the reciprocating assembly.

It is another objective of this invention to produce a piston having one lightweight ferrous piece with a wrist pin of a length necessary only to adequately transfer the combustion loads from the piston crown subject to the combustion pressure in operation to the connecting rod and thus substantially reduce weight in the reciprocating assembly and thus reduce the weight of the entire rotating assembly of connecting rods and crankshaft to improve engine fuel economy and performance;

Other objectives of the invention and a more complete understanding of the invention may be had referring to the drawings within this application.

In which:

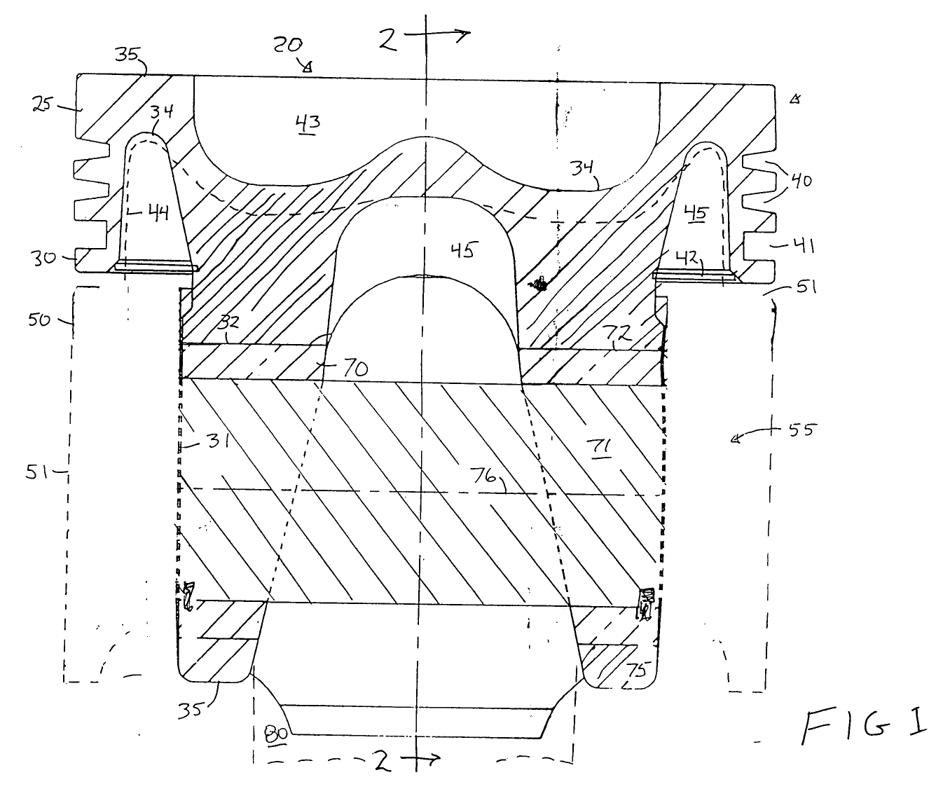

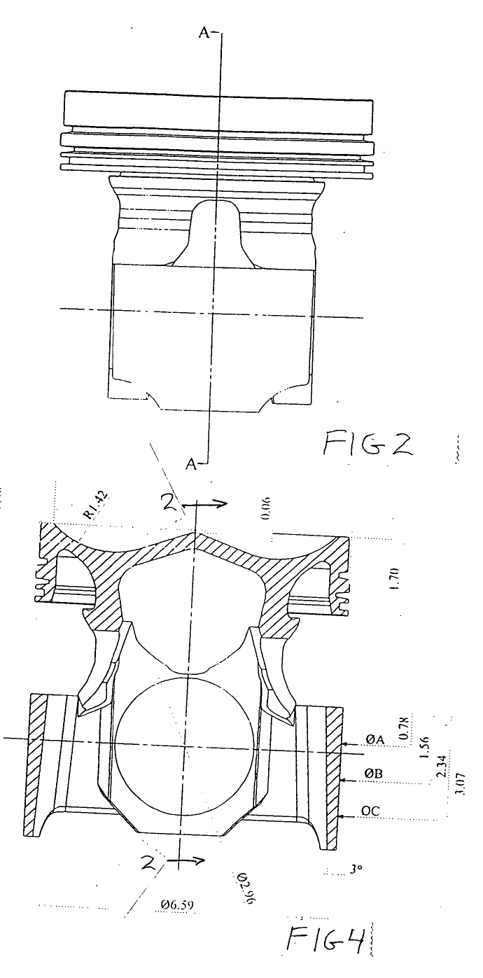

FIG. 1 is a view of a piston incorporating the present invention taken substantially along lines 1-1 in FIG. 2;

FIG. 2 is a side view of the piston of FIG. 1 taken generally along lines 2-2 of FIG. 1;

FIG. 3 is a top view of piston crown of FIG. 1;

FIG. 4 is a side view of the piston of FIG. 1; and,

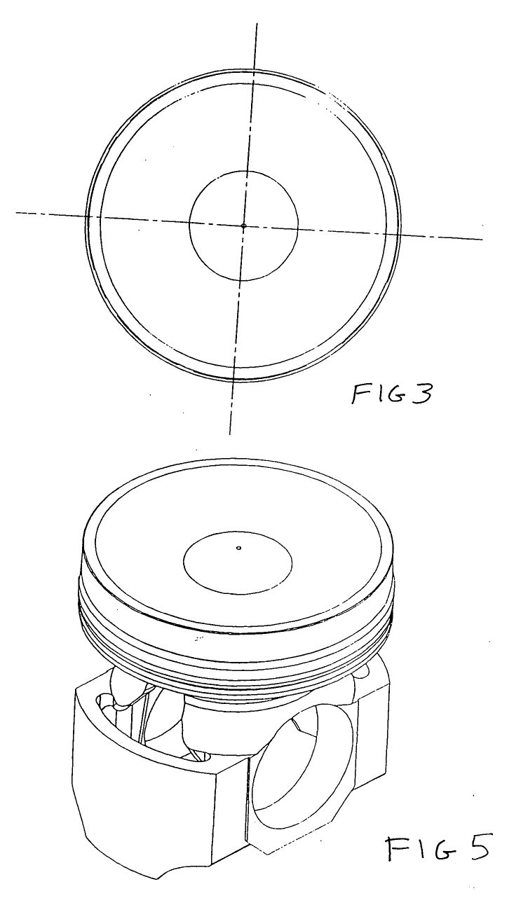

FIG. 5 is a perspective view of the piston of FIG. 1.

In addition to the known and proven ferrous materials; and while the piston 25 shown is of steel alloy it is possible to make the piston out of other metals that are subject to or adaptable to net dimensional casting methods which presently include investment casting, lost wax casting, lost foam casting, metallic and non-metallic permanent mold casting, and precision non-permanent mold casting.

This design and invention combining the use of net dimensional casting processes increases the adaptability of the piston, to numerous applications with minimal additional tooling and/or material considerations. It is also noted that the weight reduction of the precision net dimensional cast piston is particularly important wherein the reduction of reciprocating mass increases both. The efficiency and the service life longevity between repair and rebuilding operations.

In addition, the balance or weight differential as manufactured between multiple pistons is reliable and predictable for economy in maintenance of inventory, replacement purposes, and the process of dynamically and statically balancing the reciprocating and rotating masses of an engine.

This secondary operation in the embodiment disclosed includes finishing the outer surface 30 of the crown 25 (in consideration of the diameter of the cylinder in the engine), the outer edge 31 of the rod connection flange 35 (in consider of the inner dimension of the piston skirt 50), the bearing seat 32 (to match the outer diameter of the sleeve bearing 70), and the dimension of the top surface 35 of the crown 25 (to match the bearing seat 32 to the head of the engine Lo provide the desired combustion ratio at top dead center piston location). This further reduces the cost of the piston significantly over alternative processes such as forging or conventional casting.

Due to the use of a precision net to dimension casting the piston 25 can be produced of a ferrous material with a thinner cross section, a more intricate shape and with a higher initial tolerance than otherwise possible. Further features as set forth are otherwise difficult or costly to machine can be included but are not limited to a cast in place dam of planar section at or near the inner diameter of the crown for cooling oil retention, a separate metal plate so forming an oil retention dam fixed in similar place by (i) a circular spring ring, (ii) friction welding (iii) an interference fit, (iv) resistance or fill welding, and/or similar means.

The outer surface 30 of the piston crown 25 has ring grooves 40 is designed to cooperate with the piston rings (as shown in representational form in FIG. 12) and the inner wall of the cylinder liner 100 to define the lower extent of the combustion chamber. An oil groove 41 located below the rings on the outer surface of the piston crown 20 reduces friction by providing for a lubricant flow at the critical location in the engine.

Due to the use of a net to dimension cast piston blank, the process finishing the outer surface 30 is significantly reduced from alternative manufacturing processes (such as the previously described forging). Typically, only a minor secondary operation is necessary in order to provide the finish dimensions for the outer surface 30 of the crown 25 due to the accuracy of the casting process; and then primarily to provide dimensional stability for the outer surface 30, the outer edge 3 bearing seat 32 and the top surface of the crown 35. This equalizes any given piston to another so as to provide a more efficient and balanced engine and one where the uppermost ring groove is immediately adjacent to the top of the piston crown.

Further the use of a net dimensional ferrous casting, the thickness of the piston crown between the outer surface 30 and the lower confines of the swirl chamber 3 on top of the piston crown 25 and the inner surfaces 34 on the underside 45 of the crown is of a predictable and substantially constant thickness throughout as initially cast (see dashed lines 44 in FIG. 1). This constant and predictable thickness allows for the efficient transfer of heat and inconsistent reduction of heat distribution without differences within the piston crown 25. This is in addition to the reduction of weight and reliability of balance due to the accuracy of initial casting of the piston.

Further the auxiliary cooling oil, which is typically sprayed upward from a fixed location beneath the low travel extent of the piston, can penetrate further and more evenly within the piston crown 25 to provide for a more efficient and even heat removal from the piston rings 40 and the swirl chamber 43 at the top of the piston by such cooling oil.

The outer edge 31 of the rod connection flange 35 of the piston crown 23 locates the piston. Skirt relative to the piston crown 25. The outer edge 31 itself cooperates with the later described piston skirt to provide angular stability to the crown 25 in respects to the cylinder 100. This in turn evens out the wear about the circumference of the crown, thus to reduce any differential wear about the circumference of the piston.

This even distribution of wear by this edge 31 is especially true for forces perpendicular to the longitudinal axis of the wrist pin 71.

The seat 32 of the piston crown 25 is designed to retain the piston rod pin in a location relative to the piston (via sleeve bearing 70 in the embodiment shown). This serves as the main mechanical interconnection between the piston rod 80 and the piston 20. The seat 32 also cooperates with the wrist pin 71, the piston skirt 50 through the wrist pin 71 to provide angular stability of the crown 25 in respect to the cylinder 100.

It, thus, evens out any differential wear about the circumference of the piston 20. This evening out is especially true for cocking forces about the longitudinal axis of the wrist pin 71 in both those applications where pin thrust offset is used as in other form engines and otherwise.

As this seat is a circular hole extending straight through the rod connection flanges of the piston crown 25, it is amenable to a simple finishing operation due to the accuracy of the initial casting process.

A sleeve bearing 70 inserted through the rod connection flange 35 in the piston crown 25 to the wrist pin 71 and thus the connecting rod 80. The use of an independent sleeve bearing 70 allows for the optimization of materials. This also allows the sleeve bearing 70 to be of a non-ferrous metal alloy or other material suitable to a moving, high force rotary interconnection while also allowing the crown 20 to be of a different material (a ferrous or ferrous alloy disclosed).

The use of a separate sleeve bearing 70 also allows for the repair of this high stress area by the replacement a relatively simple part instead of the entire piston thus increasing the service life of the remainder of the piston 20.

The constant surface between the piston rod 80 and the piston 20 is designed such that this surface area between these two is greater in the direction of significant power transfer than the direction of return movement. For this reason, the sleeve bearing 70 has a contact surface area 72 on the piston crown 25 side of the piston 20 significantly greater than the return surface area 75. As a result of this relationship, the crown 25 has sufficient contact area to develop the power inherent in the engine incorporating same. If desired, for example to increase the tear off resistance, the contact surface area 75 can be enlarged.

It is noted that it is preferred that the sleeve bearing 70 allows the flow of pressurized oil between a passage 81 in the piston rod 80 to the oil groove 41 thus to lubricate this critical location, a plate or dam 42 closing the bottom of the galley 45 of the crown 25 provides a reservoir for this cooling oil in the various forms noted above and herein.

The piston skirt 50 completes the piston 20. Due to the dimensional stability and complexity of its associated crown 25, this skirt 50 can be of relatively simple construction. The particular piston skirt disclosed has a vertical outside surface S, a center opening 52, and a lock ring access 55. The outside surface 51 of the piston skirt 50 cooperates with the inner wall of the cylinder 100 of the engine to support the piston crown 25 against any tipping or angular displacement in respect to the longitudinal axis of the cylinder 100. As previously discussed, this support is provided through the outer edge 31 and the seat 32 of the crown 25.

To efficiently provide the support for the piston crown 25, the center opening 52 of the piston skirt 50 has two opposed flat support surfaces 53 and pin seat 54. These together cooperate with the connecting rod flange 35 as previously set forth to support the piston crown against angular movement in a side wards direction (angular cocking re: the longitudinal axis 76 of the wrist pin 71).

Insofar as there are no known forces acting axially or laterally on the piston perpendicular to the axis of the piston pin below the part of the piston crown that supports the sealing rings, all those parts of the piston usually comprising the skirt thereof regardless of material or one or two piece construction have been eliminated.

The lock ring access 55 allows for physical access to the lock rings 77 which retain the wrist pin 71 in its designed position in respect to the piston 20. This lock ring access 55 generally is a straight cut across the inner surface 51 of the piston skirt 50. This allows for efficient access to the lock ring. In addition, a lock ring access 55 can allow for a use of original wrist pins 71 should that be desired (if necessary by varying the location of the lock ring groove). The straight flat surfaces 53 are amenable to being formed in a single manufacturing step.

Although the invention has been described in its preferred forms with a certain degree of particularity, it is to be understood that numerous changes can be made without deviating from the following invention as hereinafter claimed.

1: A piston for an internal combustion, engine having a piston, rod and a wrist pin, said piston comprising in one piece a piston crown and a conjoined piston skirt, said piston crown having an outer surface, a combustion chamber, and an inner surface, the piston crown being precision cast net to finished dimensions on all inner surfaces with a substantially constant thickness between said outer surface and said combustion chamber to said inner surfaces; and to all dimensions comprising the inner and outer forms of the piston wall, skirt, and top, and said piston having two rod connection flanges, said rod connection flanges extending off of said inner surface of said piston crown, each said rod connection flanges having a lower end, each of said rod connection flanges being tapered from said inner surface of said piston crown to a reduced section at said lower end, said tapers allowing clearance for a greater contact area between the wrist pin to the piston crown at the top of said tapers and between, the wrist pin to the piston rod at the lower end of said tapers, and said piston crown surrounding said two rod connections.

2: The piston of claim 1 characterized in that such piston crown has a bottom surface as a cut away section that is removed on at least 50% of its diameter.

3: The piston of claim 1 characterized by the addition of a sleeve bearing and said sleeve bearing being located between the wrist pin and said rod connection flanges.

4: The piston of claim 1 characterized in that the piston rod has an outer surface with a reduced taper substantially matching the tapers of said rod connection flanges.

5: The piston of claim 1 characterized in that said piston has a diameter and said piston skirt has a diameter, and said diameter of said piston crown being not greater than said diameter of said piston skirt.

6: The piston of claim 1 characterized in that: The said piston has one or more embodiments of a cooling oil dam or retention plate that is cast in place by the precision casting process set forth in the description herein.

7: The piston of claim 1 characterized in that: The said piston has one or more embodiments of a cooling oil dam or retention plate that is made of a metal plate and is held in place proximally at the lower edge of the piston crown by the application of a snap ring or circle ring set in a groove as set forth in the description herein.

8: The piston of claim 1 characterized in that: The said piston has one or more embodiments of a cooling oil dam or retention plate that is made of a metal plate and is held in place proximally at the lower edge of the piston crown by the application of a bending or folding of the crown material in either the cold or warm state.

9: The piston of claim 1 characterized in that: The said piston has one or more embodiments of a cooling oil dam or retention plate that is made of a metal plate and is held in place proximally at the lower edge of the piston crown by the application of friction, spot, or fill welding.

10: The piston of claim 1 characterized in that: The said piston has one or more embodiments of a cooling oil dam or retention plate that is made of a metal plate and is held in place proximally at the lower edge of the piston crown by the application of a snap ring or circle ring set in a groove as set forth in the description herein.

11: The piston of claim 1 characterized in that: The said piston has one or more embodiments of a cooling oil dam or retention plate that is made of a metal sheet and is held in place proximally at the lower edge of the piston crown by the application of a friction, resistance, or fill welding means in a groove as set forth in the description herein.

12: The piston of claim 1 characterized in that: The said piston has one or more embodiments of a cooling oil dam or retention plate that is made of a metal sheet and is held in place proximally at the lower edge of the piston crown by the application of an interference fit between the inner and outer dimensions of said plate dam and the piston body as set forth in the description herein.

12: The piston of claim 1 characterized in that: The said piston has its uppermost or top compression ring groove located proximally to the top of the piston crown so that the dimension between the top of said sealing ring and the top of the piston is no greater than one to one and one half times the vertical dimension of the cross section of the sealing ring as set forth in the description herein.
